(19) United States
(12) Patent Application Publication
(10) Pub. No.: US 2026/0316450 A1
(43) Pub. Date: Oct. 15, 2026

(54) LIQUID EJECTION HEAD

(71) Applicant: CANON KABUSHIKI KAISHA, Tokyo (JP)

(72) Inventors: RYO SHIMAMURA, Kanagawa (JP); SHIMPEI YOSHIKAWA, Kanagawa (JP)

(21) Appl. No.: 19/576,614

(22) Filed: Mar. 24, 2026

(30) Foreign Application Priority Data
Apr. 9, 2025 (JP) 2025-064133

(51) Int. Cl. B41J 2/14; B41J 2/15; B41J 2/175; B41J 2/18; B41J 25/00

(52) U.S. Cl. CPC B41J 2/14201; B41J 2/15; B41J 2/17596; B41J 2/18; B41J 25/005; B41J 2002/14491

(57) ABSTRACT

A liquid ejection head mounted on a liquid ejection apparatus, the liquid ejection head includes an element substrate configured to eject liquid, a flexible wiring board electrically connected to the element substrate, and a contact wiring board including a plurality of contact pads configured to electrically connect to the liquid ejection apparatus and an electrical connection portion with the flexible wiring board, the electrical connection portion extending in a first direction, wherein the electrical connection portion is disposed in a region having a length less than or equal to half of a length of the contact wiring board in the first direction.

### BACKGROUND

### Field of the Technology

The present disclosure relates to a liquid ejection head.

### Description of the Related Art

A liquid ejection head is generally known to include an element substrate provided with ejection port lines for ejecting liquid and energy generation elements for ejecting the liquid each provided for a corresponding ejection port. The liquid ejection head includes a contact wiring board including a contact portion electrically connected to the main body of a liquid ejection apparatus. For example, as in a conventional example illustrated in FIGS. 24A and 24B, there is a configuration in which element substrates 801 are disposed on the bottom surface of a housing 803 of a liquid ejection head 800, and a contact wiring board 806 is disposed on a side surface of the housing 803. The contact wiring board 806 and the element substrates 801 disposed on the different surfaces of the housing 803 are generally electrically connected using a flexible wiring board 805 having flexibility.

During manufacture of a liquid ejection head, a flexible wiring board may be bent in accordance with the geometry of a housing and attached to the housing. Japanese Patent Laid-Open No. 2016-5892 discusses a liquid ejection head including a flexible wiring board fixed to a housing in a bent state.

### SUMMARY

In the conventional liquid ejection head as represented in FIGS. 24A and 24B, the flexible wiring board and the contact wiring board generally have substantially the same width. To reduce the manufacturing cost of the liquid ejection head, it is effective to reduce the area of the flexible wiring board so as to increase the number of flexible wiring boards obtainable from a base member. However, in a case where the liquid ejection head includes an element substrate with ejection ports densely arranged therein or a circulation unit, the number of electrical contacts with the liquid ejection apparatus increases, and thus the contact wiring board tends to increase in size. Further, in such a case, a large number of electrical connection terminals are typically arranged on the element substrate, and it is often difficult to simply reduce the area of the flexible wiring board.

In view of the above, the present disclosure is directed to reduction of the manufacturing cost of a liquid ejection head.

An aspect of the present disclosure provides a liquid ejection head mounted on a liquid ejection apparatus, with the liquid ejection head including an element substrate configured to eject liquid; a flexible wiring board electrically connected to the element substrate; and a contact wiring board including a plurality of contact pads configured to electrically connect to the liquid ejection apparatus and an electrical connection portion with the flexible wiring board, the electrical connection portion extending in a first direction. The electrical connection portion is disposed in a region having a length less than or equal to half of a length of the contact wiring board in the first direction.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of a liquid ejection head according to a first embodiment.

FIG. 2 is an exploded perspective view of the liquid ejection head according to the first embodiment.

FIG. 3 is a schematic view of a circulation unit according to the first embodiment.

FIG. 4 is a schematic diagram illustrating a circulation path for ink of one color according to the first embodiment.

FIG. 5 is a plan view illustrating an ejection unit according to the first embodiment.

FIG. 6 is a plan view illustrating the rear surface of an element substrate according to the first embodiment.

FIG. 7 is a plan view illustrating the rear surface of a support member according to the first embodiment.

FIG. 8 is a plan view of an element substrate unit according to the first embodiment.

FIG. 9 is a side view of the liquid ejection head according to the first embodiment as viewed from a contact wiring board side.

FIG. 10 is a cross-sectional view of the liquid ejection head according to the first embodiment taken along line X-X in FIG. 1A.

FIG. 11 is a schematic cross-sectional view illustrating a structure of a flexible wiring board according to the first embodiment.

FIG. 12 is an enlarged cross-sectional view illustrating a detail of a bent portion of the flexible wiring board of the liquid ejection head according to the first embodiment.

FIGS. 13A-13D are side views illustrating a process of folding the flexible wiring board of the liquid ejection head and performing staking according to the first embodiment.

FIG. 14 is a cross-sectional view of the liquid ejection head according to the first embodiment, illustrating parameters in a process of bending the flexible wiring board.

FIGS. 15A-15C are schematic diagrams illustrating details of the process of bending the flexible wiring board illustrated in FIG. 13B.

FIGS. 16A and 16B are diagrams each illustrating the element substrate unit disposed on the support member.

FIG. 17 is a flowchart illustrating a part of a process of manufacturing the liquid ejection head according to the first embodiment.

FIGS. 18A and 18B are side views illustrating states before and after the flexible wiring board is bent according to the first embodiment.

FIGS. 19A-19C are side views illustrating differences in inclination of the contact wiring board due to differences in width of the flexible wiring board.

FIG. 20 is a table illustrating results of behavior observed during the process of bending the flexible wiring board when a lowering speed of a roller is changed.

FIGS. 21A and 21B are side views of a liquid ejection head according to a second embodiment.

FIGS. 22A and 22B are schematic plan views each illustrating an element substrate unit according to a modification.

FIG. 23 is a diagram illustrating an example of a liquid ejection apparatus to which the present disclosure can be applied.

FIGS. 24A and 24B are perspective views each illustrating a liquid ejection head according to a conventional example.

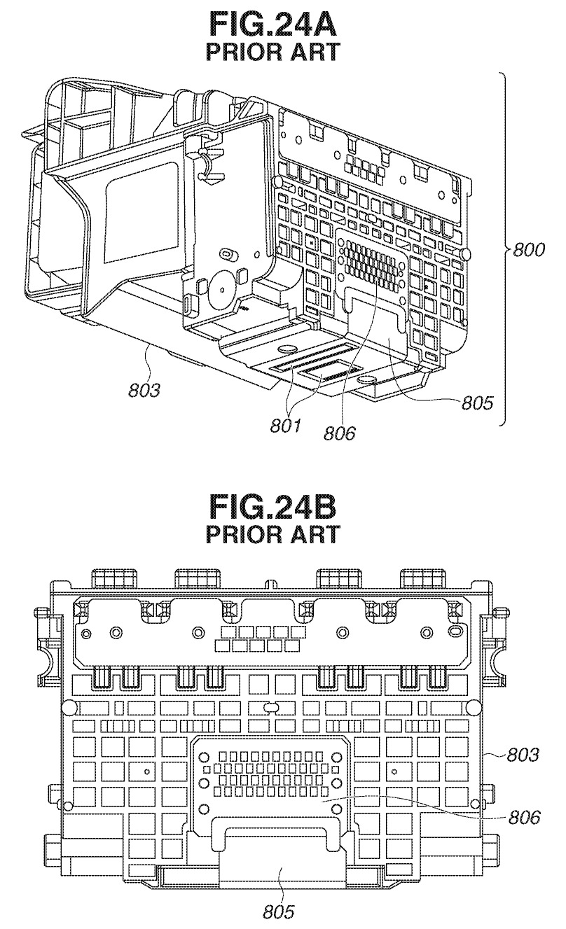

### DESCRIPTION OF THE EMBODIMENTS

Exemplary embodiments of the present disclosure will now be described in detail, without limiting the scope of the present disclosure.

In the following description, the liquid is ink, but is not limited to ink. In other words, as the liquid, various types of recording liquid may be used that include treatment liquid used to improve fixing property of ink, to reduce gloss unevenness, and to increase abrasion resistance on a recording medium. A +Y direction is on the downstream side in a conveyance direction of a recording medium 101, and a -Y direction is on the upstream side in the conveyance direction of the recording medium 101. An X direction is referred to as a main scanning direction, and the Y direction is referred to as a sub-scanning direction as appropriate. In the following description, unless otherwise specified, upper, lower, left, and right indicate directions with respect to an orientation in which a liquid ejection apparatus 1000 is used in a normal state.

As used herein, recording medium refers to not only paper used in a general liquid ejection apparatus, but also a medium that can receive liquid, such as cloth, plastic film, a metal plate, glass, ceramics, resin, wood, and leather.

Recording (also referred to as printing) is not limited to formation of significant information, such as characters and figures. Recording also means formation of insignificant information, such as images, designs, and patterns. Further, recording is not limited to formation of information so that the information is visually perceivable by a human. Thus, recording also means forming a structure on a recording medium, or processing the medium.

### First Embodiment

### Entire Configuration of Liquid Ejection Apparatus

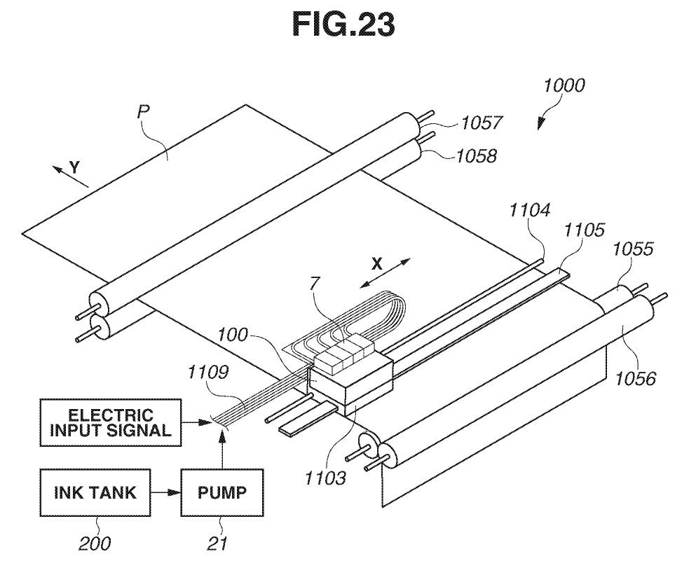

A configuration will now be described of a liquid ejection apparatus with reference to FIG. 23.

The liquid ejection apparatus 1000 includes a liquid ejection head 100 that can eject ink to perform recording and the like. The liquid ejection head 100 is mounted on a carriage 1103 that can reciprocate in the main scanning direction (±X direction). The carriage 1103 is supported by a guide shaft 1104 extending in the main scanning direction so as to be slidable along the guide shaft 1104. The carriage 1103 is fixed to an endless belt 1105 disposed in parallel with the guide shaft 1104.

In a state where the carriage 1103 is fixed to the endless belt 1105, an ejection port surface of the liquid ejection head 100 including ejection ports for ejecting the ink is maintained to face a platen supporting a recording medium P from a -Z direction side, and is maintained parallel to the platen. Rotation of a driving pulley driven by a carriage motor moves the endless belt 1105 in the left direction (the -X direction) or in the rightward direction (the +X direction). The movement of the endless belt 1105 in the main scanning direction also causes the carriage 1103 to reciprocate in the main scanning direction along the guide shaft 1104.

In the present embodiment, one or more (four in the present embodiment) liquid circulation units 7 that can circulate ink within the liquid ejection head 100 are mounted on the liquid ejection head 100. A cover that covers the liquid circulation units 7 is actually provided. However, for convenience of description, the cover is not illustrated.

Electrical wiring for transmitting electrical signals for ejection operation, tubes for supplying ink from an ink tank 200 via a pump 21, and a pipe for supplying air are connected to the liquid ejection head 100. The electrical wiring, the tubes, and the pipe are guided to the liquid ejection head 100 along a guide 1109.

In the present embodiment, the ink of four colors, namely, cyan, magenta, yellow, and black (CMYK) is individually supplied to the four liquid circulation units 7. The liquid ejection head 100 allows full-color printing using the ink of the four colors. The colors of the ink applicable to the present embodiment are not limited to these four colors. The colors of the ink may be three or fewer colors or five or more colors including colors other than the above-described colors. A liquid ejection head that performs monochrome printing by ejecting only black ink, or a liquid ejection head that ejects reaction liquid or the like other than ink may be employed.

The recording medium P is conveyed in the sub-scanning direction as the Y direction intersecting (in the present embodiment, orthogonal to) the main scanning direction by conveyance rollers 1055, 1056, 1057, and 1058. The liquid ejection apparatus 1000 moves the liquid ejection head 100 in the main scanning direction and causes the liquid ejection head 100 to eject ink while intermittently moving the recording medium P to the downstream side (the +Y direction side) in the conveyance direction, recording an image. As described above, the liquid ejection apparatus 1000 according to the present embodiment is a serial inkjet printer.

Further, a restoration mechanism for maintaining and restoring ejection performance of the ejection ports is provided in the liquid ejection apparatus 1000. The restoration mechanism is disposed in a non-recording region provided in the vicinity of a reference position (a home position) for scanning by using the liquid ejection head 100. The restoration mechanism includes a cap for sealing the ejection ports, and a wiper for scraping off excess ink and the like on the ejection port surface where the ejection ports are formed. During non-recording, the cap is relatively moved to a position where the cap covers the ejection port surface. Suction and the like are then performed to prevent the ejection ports from drying, to fill the ink, or to restore the ejection performance.

### Entire Configuration of Liquid Ejection Head

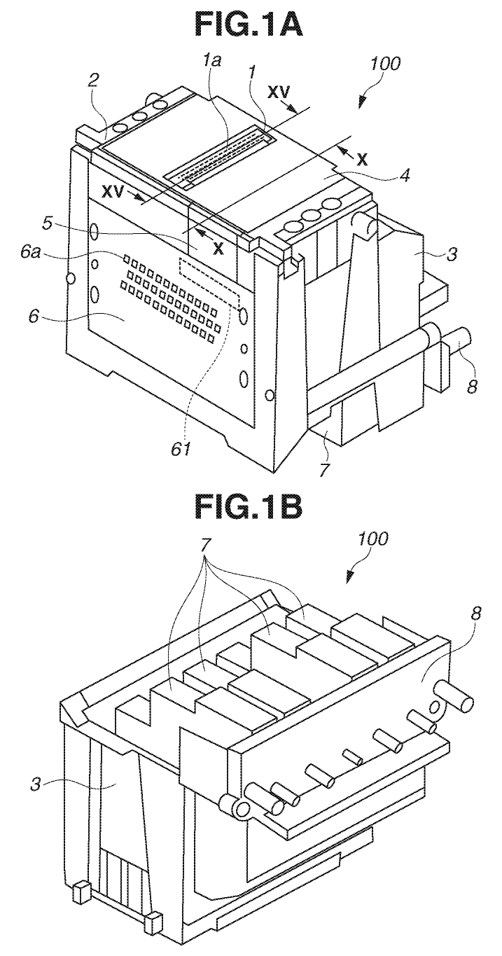

FIG. 1A is a perspective view of the liquid ejection head 100 according to the first embodiment as viewed from a contact wiring board 6 side.

The liquid ejection head 100 includes an element substrate 1, a support member 2, a flow path member 3, a cover member 4, a flexible wiring board 5, and the contact wiring board 6. The element substrate 1 is a silicon substrate in which a plurality of ejection elements for ejecting liquid, such as ink, from ejection ports, and electrical wiring for supplying power to each ejection element are formed using a film formation technique. On the silicon substrate, a nozzle line 1a in which a plurality of flow paths and a plurality of ejection ports corresponding to the ejection elements are arranged is formed using a photolithography technique and the like. A plurality of lines of supply ports for supplying ink to a plurality of nozzle lines 1a is formed in the rear surface of the silicon substrate, i.e., in the rear surface of the element substrate 1.

The element substrate 1 is bonded and fixed to the support member 2. The supply ports of the element substrate 1 and a space formed inside the support member 2 configure a liquid chamber that houses the ink. The liquid ejection head 100 includes the plurality of nozzle lines 1a, and can eject a plurality of types of liquid (ink). The ejection elements according to the present embodiment are electrothermal conversion elements (hereinafter, referred to as heaters). However, a liquid ejection head that uses piezoelectric elements as the ejection elements can be applied to the present disclosure.

The support member 2 holds the element substrate 1 and the flexible wiring board 5 by bonding the element substrate 1 and the flexible wiring board 5. The element substrate 1 and the flexible wiring board 5 are electrically connected to each other, and the support member 2 holds the flexible wiring board 5 so that the flexible wiring board 5 and the element substrate 1 are electrically connected to each other. The flexible wiring board 5 is electrically connected to the contact wiring board 6, configuring an electrical wiring portion of the liquid ejection head 100. This electrical wiring portion is disposed in a region having a length less than or equal to half of a width W2 of the contact wiring board 6. The contact wiring board 6 includes external signal input terminals (hereinafter, referred to as contact pads) 6a for receiving electrical signals from the main body of the liquid ejection apparatus 1000, and the contact wiring board 6 is positioned and fixed on the rear surface side of the flow path member 3.

The contact wiring board 6 is electrically connected to the flexible wiring board 5 through an electrical connection portion 61. In the liquid ejection head 100 according to the present embodiment, the electrical connection portion 61 is provided on the surface opposite to the surface of the contact wiring board 6 where the contact pads 6a are provided, as illustrated using broken lines in FIG. 1A. Examples of a method of fixing the contact wiring board 6 to the flow path member 3 include staking, adhesive bonding, and fixing with double-sided tape. In the present embodiment, the electrical connection between the flexible wiring board 5 and the contact wiring board 6 is formed using anisotropic conductive film (ACF) pressure-bonding. The electrical connection may be performed using wire bonding or flying lead bonding.

In the flow path member 3, a flow path is formed by laminating three members. The three members are integrally molded to form the flow path extending from a joint member 8 to the liquid chamber of the support member 2. The electrical signals for ejecting ink are input from the main body of the liquid ejection apparatus 1000 to the element substrate 1 via the electrical wiring portion.

As described above, the element substrate 1 and the flexible wiring board 5 are bonded and fixed to the support member 2. The cover member 4 is bonded to the support member 2 so as to cover surfaces of the element substrate 1 and the flexible wiring board 5. The element substrate 1 and the flexible wiring board 5 are electrically connected by wire bonding. The electrical connection method may be flying lead bonding or the like. The cover member 4 includes an opening for exposing the element substrate 1. The support member 2 and the flow path member 3 may be connected by bonding using an adhesive, or may be fixed by screw fastening with a seal member interposed therebetween.

FIG. 1B is a perspective view of the liquid ejection head 100 illustrated in FIG. 1A as viewed from the surface opposite to the contact wiring board 6, which is the side of the joint member 8 for supplying the ink to the liquid ejection head 100 from the outside. A plurality of sub-tanks 7 is assembled to the flow path member 3. The joint member 8 connected to the sub-tanks 7 to form flow paths is assembled to the flow path member 3.

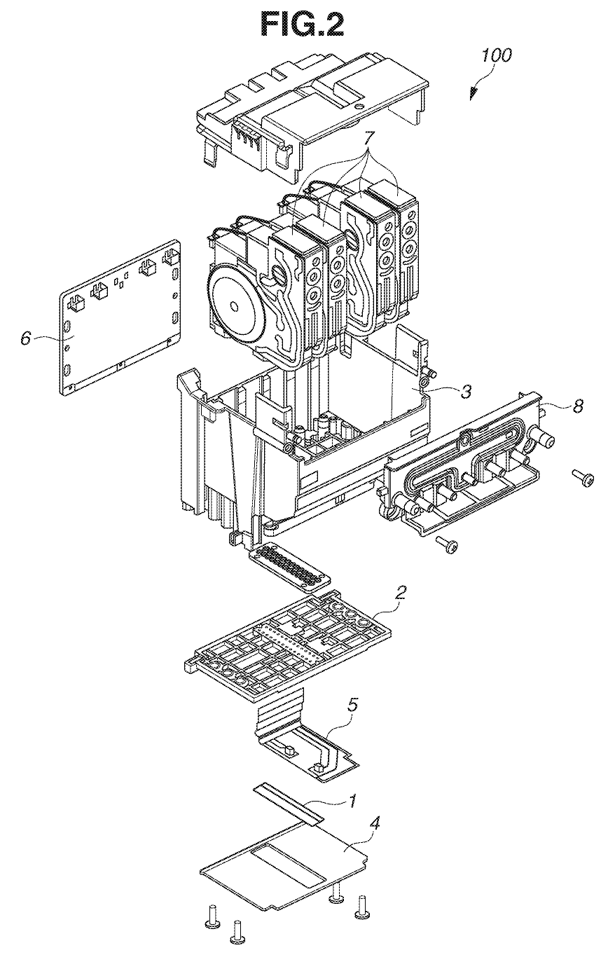

FIG. 2 is an exploded perspective view illustrating the liquid ejection head 100 according to the present embodiment. The sub-tanks 7 included in the liquid ejection head 100 according to the present embodiment are liquid circulation units 7. The number of liquid circulation units 7 provided corresponds to the number of types of liquid ejected from the element substrate 1. Since the liquid ejection head 100 according to the present embodiment ejects the ink of the four colors, namely, magenta, yellow, black, and cyan, the liquid ejection head 100 includes the sub-tanks 7 (7m, 7y, 7k, and 7c) corresponding to the ink of the colors. Each of the sub-tanks 7 is connected to the flow path member 3. The sub-tanks 7 and the flow path member 3 may be connected by screwing with a seal member interposed therebetween or by welding. The joint member 8 for receiving the ink from the main body of the liquid ejection apparatus 1000 is connected to the flow path member 3, and communicates so as to be connected to the liquid circulation units 7a to 7d. When the liquid ejection head 100 is mounted on the main body of the liquid ejection apparatus 1000, supply tubes each corresponding to the ink of the color are connected to the joint member 8 from the main body of the liquid ejection apparatus 1000. The ink supplied through the supply tubes is supplied to the corresponding sub-tanks (the corresponding liquid circulation units) 7a to 7d through the joint member 8 connected to the flow path member 3. The support member 2 is connected to the bottom surface of the flow path member 3. The ink supplied to the sub-tanks 7 is supplied to the element substrate 1 (refer to FIG. 1A) through the flow path member 3 and the support member 2.

### Circulation Path

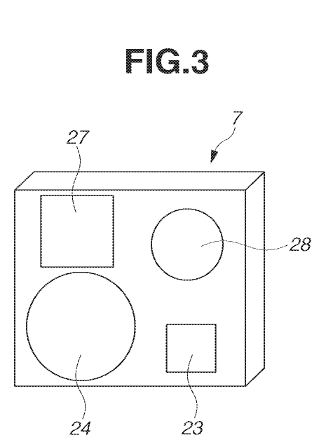

FIG. 3 is a schematic external view of a sub-tank 7 serving as a liquid circulation unit applied to the liquid ejection head 100 according to the present embodiment. Each sub-tank 7 includes a first pressure control mechanism 24, a second pressure control mechanism 28, a filter 23, and a circulation pump 27.

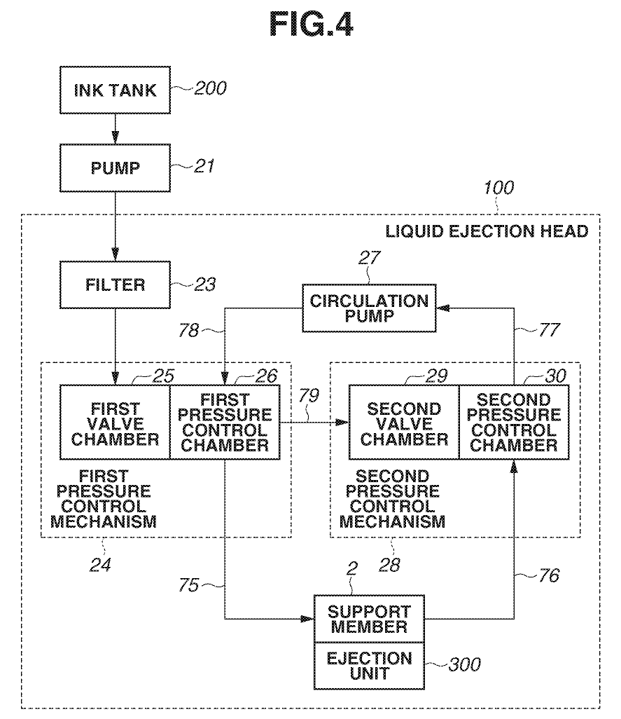

FIG. 4 is a schematic diagram illustrating a circulation path corresponding to one type of ejection liquid (ink of one color) applied to the liquid ejection apparatus according to the present embodiment. The liquid is pressurized and supplied from the ink tank 200 to the liquid ejection head 100 by the pump 21. After dust is removed from the liquid using the filter 23, the liquid is supplied to a first valve chamber 25 of the first pressure control mechanism 24. Thereafter, pressure of the liquid is adjusted when the liquid flows through a valve into a first pressure control chamber 26 communicating with the first valve chamber 25. The circulation pump 27 is a piezoelectric diaphragm pump that changes the volume of a pump chamber by applying a driving voltage to a piezoelectric element bonded to a diaphragm, generating pressure fluctuations. The pressure fluctuations alternately operate two check valves to pump the liquid. The circulation pump 27 is driven to supply liquid from a pump inlet flow path 77 on the downstream side to a pump outlet flow path 78 on the upstream side. The liquid adjusted in pressure inside the first pressure control chamber 26 is supplied to a supply flow path 75 and to a bypass flow path 79 by driving of the circulation pump 27.

The supply flow path 75 is included in the flow path member 3, and the supply flow path 75 is connected to an ejection unit 300 including the element substrate 1 and the support member 2. A collecting flow path 76 is also included in the flow path member 3, and the collecting flow path 76 is connected to the ejection unit 300. The liquid supplied to the supply flow path 75 passes through the ejection ports formed in the element substrate 1 of the ejection unit 300, is discharged to the collecting flow path 76, and then is supplied to a second pressure control chamber 30 of the second pressure control mechanism 28. The liquid supplied to a second valve chamber 29 of the second pressure control mechanism 28 is supplied to the second pressure control chamber 30 communicating with the second valve chamber 29 through a valve. The liquid supplied to the second pressure control chamber 30 is supplied to the pump inlet flow path 77, passes through the circulation pump 27, is supplied to the pump outlet flow path 78, and is then supplied to the first pressure control chamber 26. Such a configuration in which the liquid passes through the ejection ports of the element substrate 1 and is circulated by the circulation pump 27 can prevent increase in viscosity of the liquid in the vicinity of the ejection ports of the element substrate 1.

### Flow Path Configuration of Ejection Unit

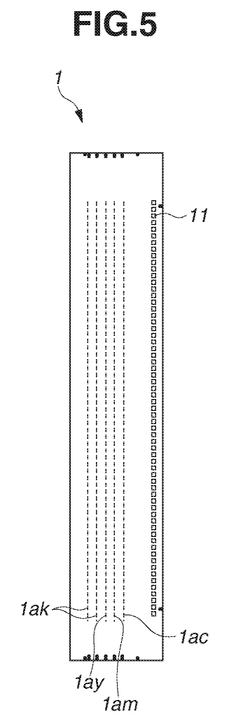

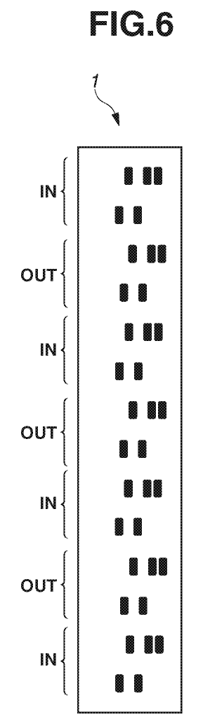

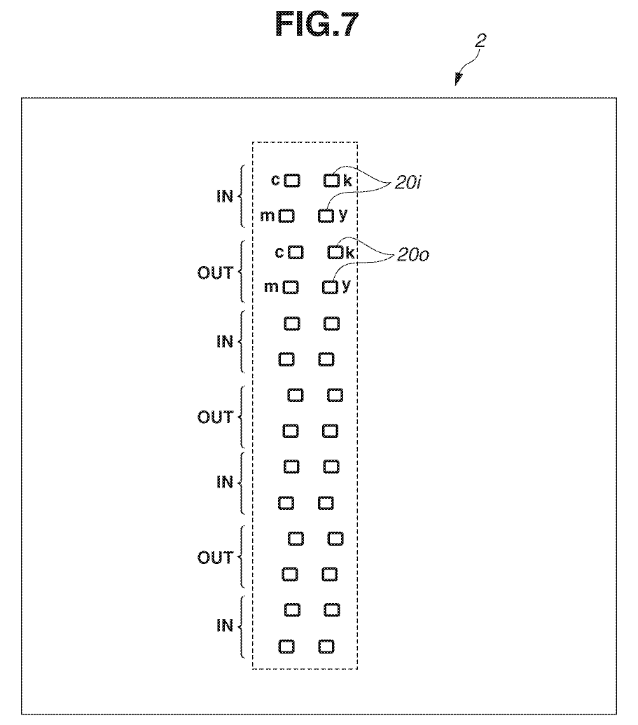

FIG. 5 is a front view of the element substrate 1. FIG. 6 is a back view of the element substrate 1. FIG. 7 is a back view of the support member 2. As illustrated in FIG. 1A, one element substrate 1 is disposed in the liquid ejection head 100 according to the present embodiment. The element substrate 1 includes five nozzle lines, i.e., nozzle lines 1ac, 1am, 1ay, and two nozzle lines 1ak. As illustrated in FIGS. 6 and 7, the element substrate 1 and the support member 2 each include a plurality of openings. The liquid is supplied from the supply flow path 75 to openings 20i indicated by IN, passes through the flow path included in the element substrate 1, and is discharged to the collecting flow path 76 from openings 20o indicated by OUT.

In this case, four openings 20i and three openings 20o are provided in each nozzle line. The numbers of openings 20i and the openings 20o are not limited to a combination of four and three. A larger number of openings may be provided, or a single large opening over the entire nozzle lines may be provided.

### Connection Configuration of Element Substrate Unit

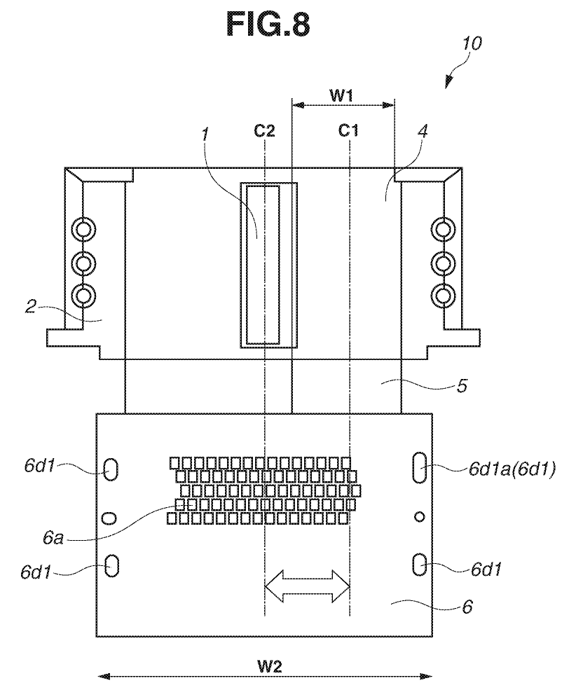

FIG. 8 is a plan view of an element substrate unit 10 included in the liquid ejection head 100 according to the first embodiment. The element substrate unit 10 includes the element substrate 1, the support member 2, the cover member 4, the flexible wiring board 5, and the contact wiring board 6. In the liquid ejection head 100 according to the present embodiment, the plurality of types of liquid (ink) is ejected, and the liquid circulation mechanisms are provided corresponding to the number of types of liquid. Thus, the number of the contact pads 6a included in the contact wiring board 6 is relatively large. In order to arrange a large number of electrode terminals 11 corresponding to the large number of contact pads 6a on the element substrate 1, the element substrate 1 includes the plurality of electrode terminals 11 along a long side of the element substrate 1. Consequently, as illustrated in FIG. 8, the flexible wiring board 5 having a width W1 is connected so as to be offset to a region having a length less than or equal to half of the length of the contact wiring board 6 having the width W2 in a width direction.

A white hollow arrow illustrated in FIG. 8 indicates the deviation between a center C2 of the width W2 of the contact wiring board 6 and a center C1 of the width W1 of a bent portion of the flexible wiring board 5 in the width direction. The center C1 of the bent portion of the flexible wiring board 5 is offset to one side with respect to the center C2 of the contact wiring board 6.

Thus, the electrical connection portion 61 of the contact wiring board 6 electrically connected to the flexible wiring board 5 is disposed in the region having the length less than or equal to half of the length of the contact wiring board 6 in the width direction (a first direction). In the configuration according to the present embodiment, in particular, the electrical connection portion 61 is disposed in a region on one side of the center of the contact wiring board 6 in the width direction.

Further, the contact wiring board 6 has holes 6d1 for staking to the flow path member 3. Of the holes 6d1, an opening area of a hole 6d1 aclosest to the flexible wiring board 5 is greater than opening areas of the other holes 6d1. The contact wiring board 6 may be electrically connected to the flexible wiring board 5 after the element substrate unit 10 is assembled to the flow path member 3.

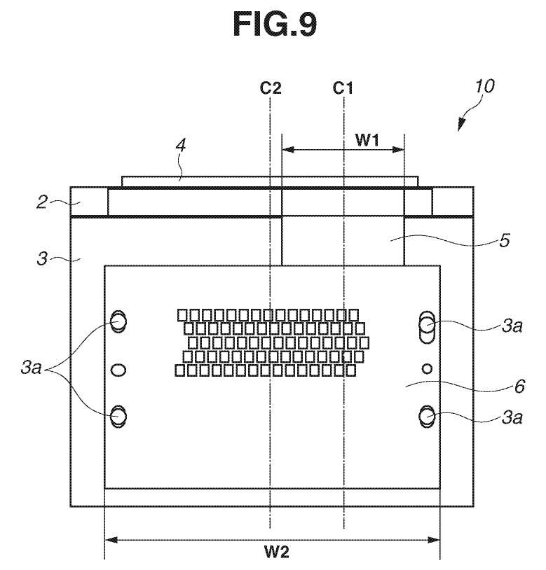

FIG. 9 is a diagram illustrating the element substrate unit 10 assembled to the flow path member 3, as viewed from the contact wiring board 6 side. The element substrate unit 10 is fixed by screw fastening using tapping screws or the like. The flexible wiring board 5 is bent along a side of the support member 2, and is then staked to staking pins 3a provided in the flow path member 3. In the liquid ejection head 100 according to the present embodiment, the center C1 of the bent portion of the flexible wiring board 5 is offset to the right of the center C2 of the contact wiring board 6.

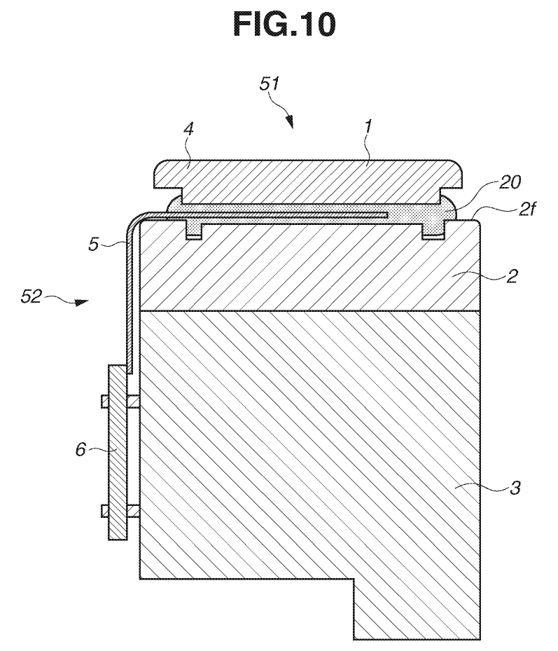

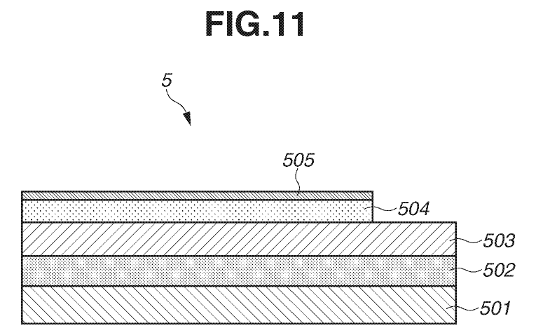

FIG. 10 is a cross-sectional view of the liquid ejection head 100 taken along line X-X illustrated in FIG. 1A. The flexible wiring board 5 is fixed to a bonding surface 2f (a first surface) of the support member 2 with an adhesive 20. The flexible wiring board 5 includes a first portion 51 that serves as an electrical bonding portion for supplying electrical signals to the element substrate 1, and a second portion 52 that serves as an electrical bonding portion for supplying electrical signals to the element substrate 1 via the contact wiring board 6. The first portion 51 and the second portion 52 are separated by the bent portion bent along the side of the support member 2 as a boundary. The flexible wiring board 5 according to the present embodiment is a single- layer flexible printed circuit (FPC). As an example, the single-layer FPC includes a base film 501 (a polyimide having a film thickness of 50 μm), over which a copper foil 503 (having a film thickness of 35 μm) as a conductive layer is laminated via an adhesive 502 as illustrated in FIG. 11. Further, the single-layer FPC includes a cover film 505 (having a film thickness of 4.4 μm) laminated and bonded over the copper foil 503 via an adhesive 504. The flexible wiring board 5 is not limited to such a single-layer FPC, and may be, for example, a two-layer FPC including two copper foils as conductive layers formed by laminating the above-described structure twice, or may be a multilayer FPC including three or more conductive layers.

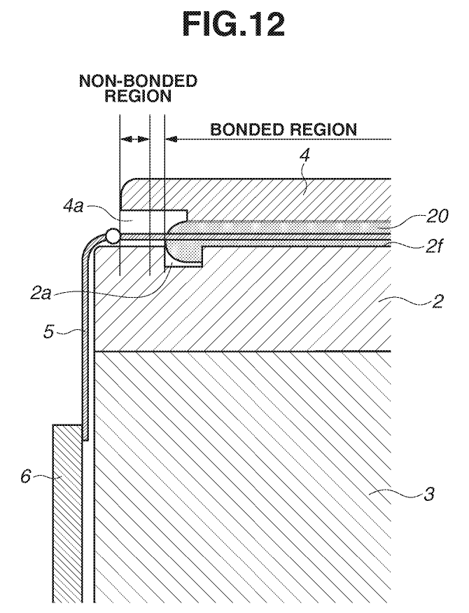

FIG. 12 is an enlarged cross-sectional view illustrating a part of the bent portion of the flexible wiring board 5 illustrated in FIG. 10. As described above, the flexible wiring board 5 is bonded over the bonding surface 2f of the support member 2 via the adhesive 20. Further, the cover member 4 is bonded over the flexible wiring board 5 via the adhesive 20. As an example, a thermosetting material is used for the adhesive 20, and the adhesive 20 is cured and hardened by heat-curing at a predetermined temperature. In the present embodiment, an epoxy-based resin material having relatively high hardness after being cured (Shore D hardness of 60 Hs or more, and curing conditions: 120° C for three minutes) is used. In the present embodiment, the adhesive between the support member 2 and the flexible wiring board 5 is the same as the adhesive between the flexible wiring board 5 and the cover member 4. However, different adhesives may be used.

In the liquid ejection head 100 according to the present embodiment, the support member 2 and the cover member 4 have a non-bonded region with the flexible wiring board 5 between a bonding portion with the flexible wiring board 5 and a bending starting point (a white circle in FIG. 12) of the bent portion of the flexible wiring board 5. In this case, the non-bonded region portion refers to a region on the bonding surface 2f close to the bent portion in the non-bonded region where the flexible wiring board 5 is not bonded to the support member 2. Further, the bending starting point refers to a point where the flexible wiring board 5 starts to be bent along the side of the support member 2. Further, the non-bonded region has a space formed on the same surface as the bonded surface of the flexible wiring board 5. The space may be provided in the vicinity of the bent portion.

By providing the starting point of the bent portion of the flexible wiring board 5 in the non-bonded region, it is possible to prevent application of external force other than bending force to the flexible wiring board 5, and to perform bending-and-staking in which the flexible wiring board 5 is bent along the support member 2 with the same starting point at all times.

A notch 4a having a smaller thickness than the other portions is formed on the bent portion side in the bonding surface of the cover member 4. Further, a concave groove 2a is provided in the bonding surface 2f of the support member 2. The notch 4a and the groove 2a prevent the adhesive 20 from protruding into the vicinity of the bent portion of the flexible wiring board 5 and store the adhesive 20 in the space of the notch 4a and the groove 2a.

Specifically, the support member 2 has the groove 2a that can store the adhesive 20 between the starting point of the bent portion of the flexible wiring board 5 and the element substrate 1 in a direction parallel to the bonding surface 2f (the first surface). The cover member 4 is configured to form a space between the starting point of the bent portion of the flexible wiring board 5 and the element substrate 1 in a direction parallel to a surface of the cover member 4, and the space is formed with the notch 4a provided in the cover member 4. Further, the space between the cover member 4 and the flexible wiring board 5 may be formed via a structure other than the notch 4a. This makes it possible to more reliably ensure a non-bonded region in the vicinity of the bent portion of the flexible wiring board 5, preventing protrusion of the adhesive 20 into the bent portion.

### Process of Bending Flexible Wiring board

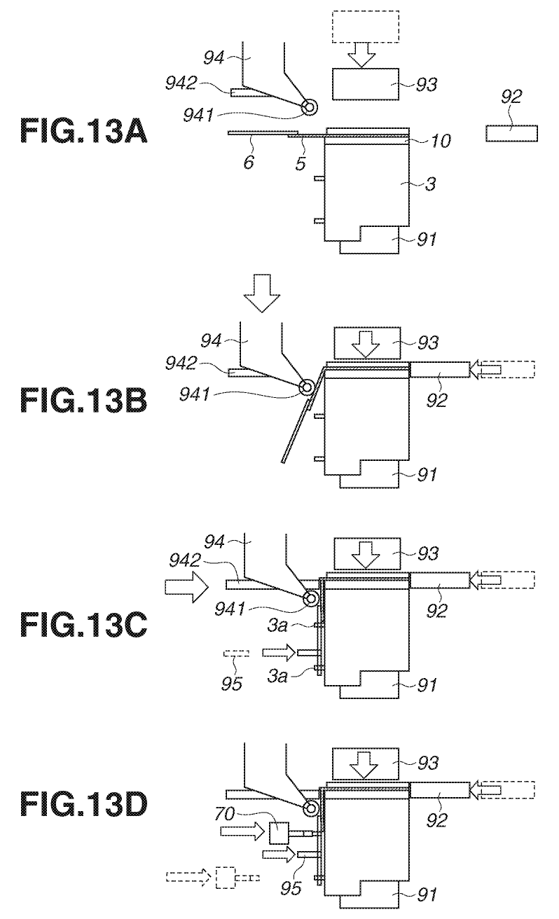

A procedure for bending and fixing the flexible wiring board 5 of the liquid ejection head 100 according to the present embodiment is described with reference to FIGS. 13A-13D. In the procedure, an adhesive and a sealant used in forming the element substrate unit 10 are heat-cured, and in a state illustrated in FIGS. 13A-13D, these materials are hardened.

As illustrated in FIG. 13A, the element substrate unit 10 in which the support member 2 of the element substrate unit 10 is assembled to the flow path member 3 is prepared, and is placed on a workpiece table 91 of an assembling device. The element substrate unit 10 is fixed and held by a clamp mechanism of the assembling device. The assembling device is used to assemble the element substrate unit 10 to the flow path member 3, and performs bending of the flexible wiring board 5 and staking of the contact wiring board 6.

Next, as illustrated in FIG. 13B, a support member backup 92 advances toward the support member 2 to complete positioning of the element substrate unit 10. Thereafter, a Z presser 93 is lowered, and a bending unit 94 is also lowered to bend the flexible wiring board 5. The bending unit 94 includes a roller 941 and a bending block 942. The roller 941 and the bending block 942 move in synchronization in the lowering operation of the bending unit 94.

Subsequently, as illustrated in FIG. 13C, the bending block 942 advances toward the flow path member 3 to press the bent portion of the flexible wiring board 5. At this time, the pins 3a provided in the flow path member 3 are inserted into the corresponding holes 6d1 (refer to FIGS. 8 and 9) provided in the contact wiring board 6. As described above, the process of pressing the bent portion (FIG. 13B) is performed before the process of fixing the contact wiring board 6 (FIG. 13C).

This makes it possible to fix the flexible wiring board 5 with reaction force acting on the bent portion restrained while the vertical position of the flexible wiring board 5 is restricted within a range defined by the size of the holes 6d1.

Then, as illustrated in FIG. 13D, a contact wiring board positioning member 95 advances toward the flow path member 3 and holds the contact wiring board 6 at a predetermined position. A horn 70 then stakes the pins 3a.

The contact wiring board 6 is staked to the flow path member 3 at two or more positions. In the present embodiment, as illustrated in FIG. 9, two staking portions are each provided on the upper part and the lower part of the contact wiring board 6, i.e., four staking portions in total. The staking order is not limited, and staking of the upper part and the lower part of the contact wiring board 6 may be performed in any order.

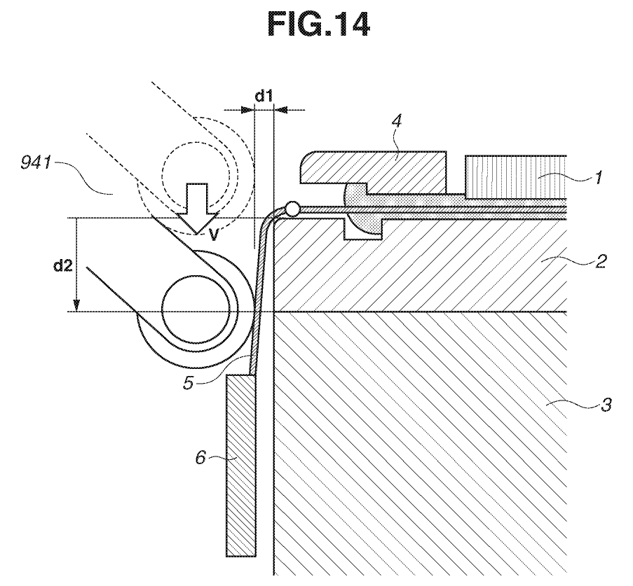

FIG. 14 is a cross-sectional view of a main part of the bent portion illustrating parameters relating to the process of bending the flexible wiring board 5. The parameters of the assembling device in the bending process include a distance d1 from the roller 941 to a workpiece (a side surface of support member 2), a distance d2 from the upper surface (the bonding surface 2f) of the support member 2 to a lowering-end (the roller-center) position of the roller 941, and a lowering speed v of the roller 941. The distance d1 is set in consideration of a bulge in the flexible wiring board 5 after bending. It is sufficient to set the distance d2 so that the flexible wiring board 5 is at a bendable position and a distance is maintained for the bending block 942 illustrated in FIG. 13C to reach (advance). The lowering speed v can be set to a value as an input value of the assembling device.

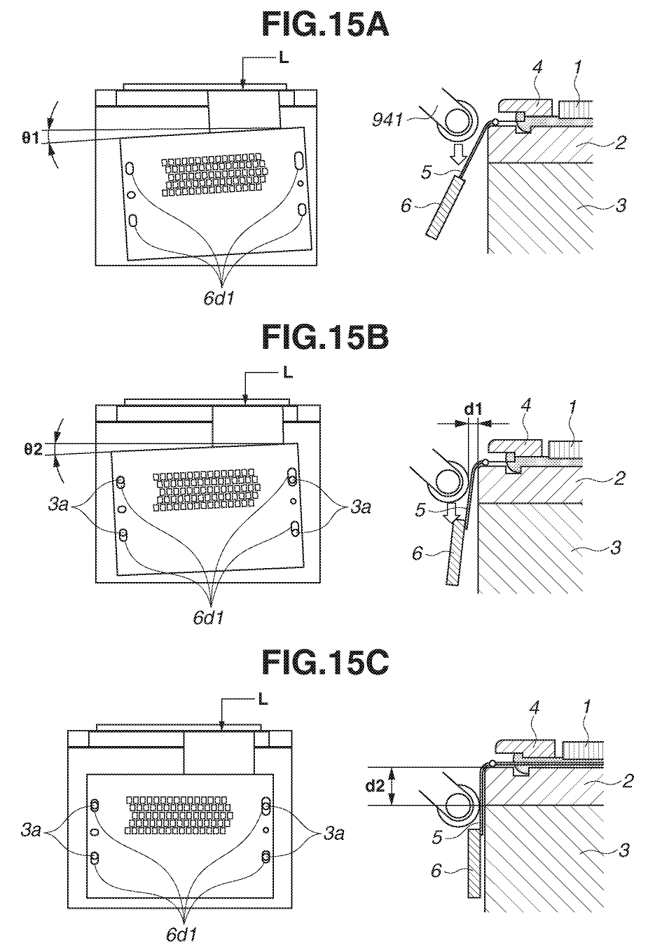

FIGS. 15A-15C are diagrams illustrating the bending process illustrated in FIG. 13B in more detail. FIGS. 15A-15C are diagrams as viewed from the contact wiring board 6 side and cross-sectional views in the vicinity of the bent portion.

A position illustrated in the cross-sectional views corresponds to the position of line XV-XV illustrated in FIG. 1A. FIG. 15A illustrates a state immediately before the roller 941 comes into contact with the flexible wiring board 5, FIG. 15B illustrates a state where the roller 941 comes into contact with the flexible wiring board 5 and is lowered, and FIG. 15C illustrates a state where the roller 941 is stopped at the lowering end.

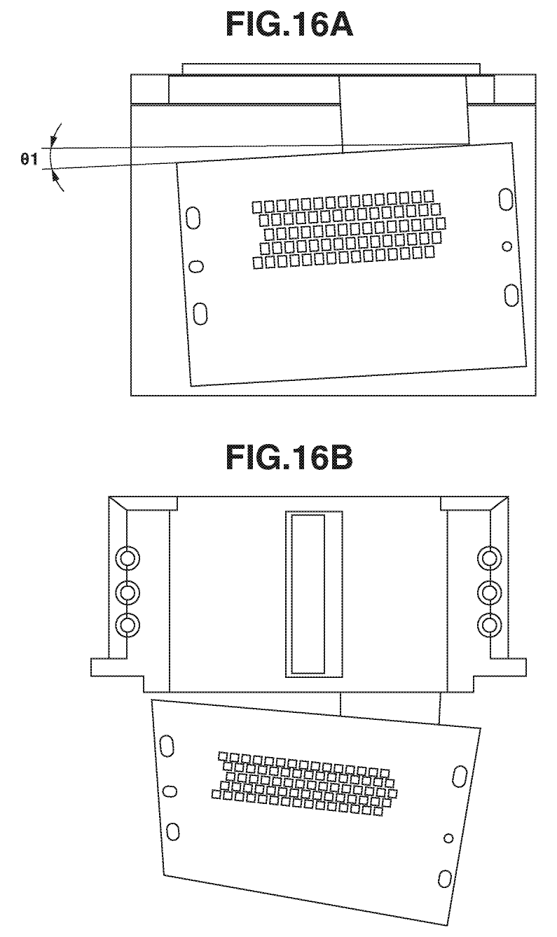

The contact wiring board 6 before being fixed to the flow path member 3 illustrated in FIG. 15A is inclined at an angle θ1 with respect to a side L of the bonding surface 2f of the support member 2 that overlaps with the bent portion of the flexible wiring board 5. This is because the flexible wiring board 5 is connected in the region, to which the flexible wiring board 5 is offset, having the length less than or equal to half of the length of the contact wiring board 6 in the width direction. In such a configuration, the flexible wiring board 5 disposed on the assembling device before being bent is twisted due to influence of the weight of the contact wiring board 6, and the contact wiring board 6 is inclined in some cases. FIG. 16A is a diagram illustrating the element substrate unit 10 disposed on the support member 2 in the state illustrated in FIG. 15A as viewed from the contact wiring board 6 side, and FIG. 16B is a diagram as viewed from the element substrate 1 side. The side of the contact wiring board 6 to which the flexible wiring board 5 is not connected is inclined to the support member 2. When the flexible wiring board 5 is bent in such a state, the pins 3a of the flow path member 3 cannot be inserted into the holes in the contact wiring board 6 due to the influence of impact and reaction force at the time of bending, which prevents staking in some cases.

FIG. 15B illustrates the state where the roller 941 is lowered. The roller 941 is separated from the side surface of the support member 2 by the distance d1, and the flexible wiring board 5 can freely move within the range of the distance d1 with lowering operation of the roller 941 without being restrained. Specifically, the flexible wiring board 5 moves with lowering of the roller 941 so that the pin 3a is first inserted into the hole 6d1 having the largest opening area of the contact wiring board 6. Further, the position of the contact wiring board 6 is corrected in the direction of the white hollow arrow in the FIG. 15B so as to reduce an inclination θ2 (θ2 < θ1) of the contact wiring board 6.

FIG. 15C illustrates the state where the roller 941 is stopped at the lowering end. The position of the contact wiring board 6 is corrected so as to be parallel to a bending ridgeline L of the flexible wiring board 5, and thus, the contact wiring board 6 is disposed at a position where the pins 3a can be inserted into the holes 6d.

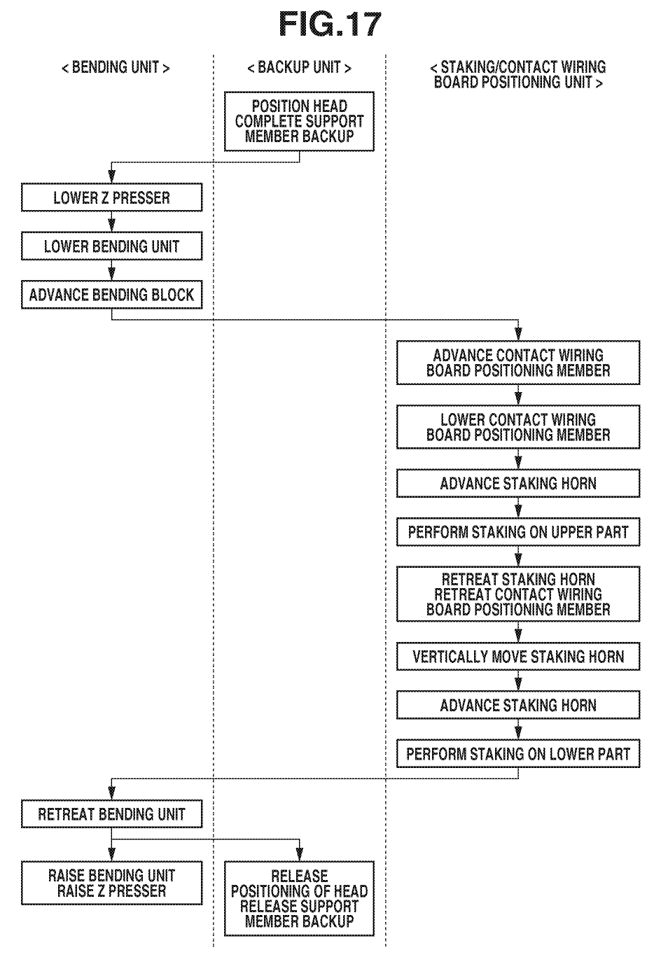

FIG. 17 is a diagram illustrating a procedure for a part of a process of manufacturing the liquid ejection head 100 according to the present embodiment, and illustrates a procedure for assembling the element substrate unit 10 to the flow path member 3. In the process of bending the flexible wiring board 5 using the roller 941, the flexible wiring board 5 is bent at a position included in the non-bonded region as a starting point while the contact wiring board 6 is corrected so as to be parallel to the side L of the support member 2. In the procedure illustrated in FIG. 17, this process is performed in a process of lowering the bending unit 94.

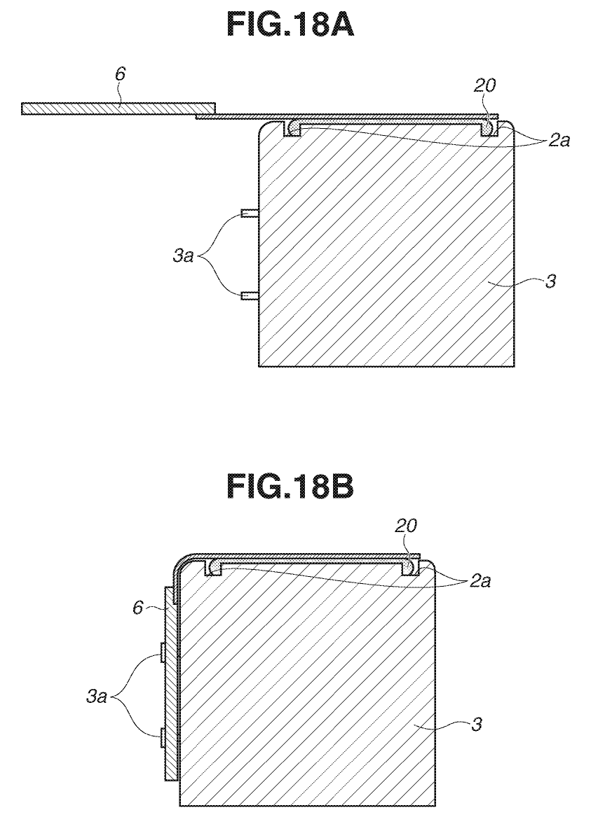

FIGS. 18A and 18B are cross-sectional views illustrating states before and after the flexible wiring board 5 is bent, and correspond to the position of line X-X illustrated in FIG. 1A. FIG. 18A illustrates the state before the flexible wiring board 5 is bent, and FIG. 18B illustrates the state where the flexible wiring board 5 is bent and fixed to the flow path member 3.

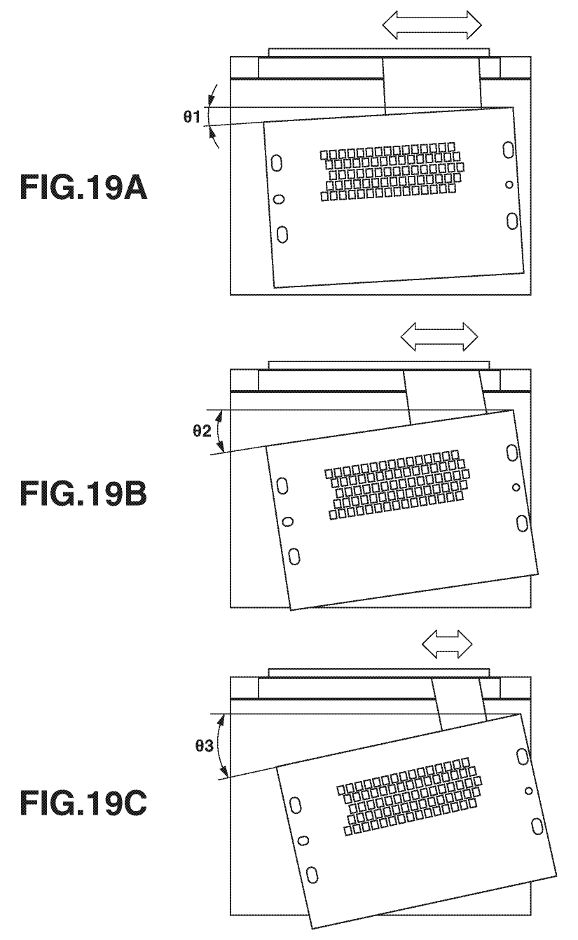

FIGS. 19A-19C are diagrams, which correspond to FIG. 15A, each illustrating a state before the contact wiring board 6 is fixed to the flow path member 3 and an example in which the bent portion of the flexible wiring board 5 has different widths. When only the width of the bent portion of the flexible wiring board 5 is changed to 36 mm (FIG. 19A), 30 mm (FIG. 19B), and 16 mm (FIG. 19C) using the same contact wiring board 6, an inclination θ of the contact wiring board 6 increases (θ1 < θ2 < θ3) as the width of the bent portion of the flexible wiring board 5 decreases.

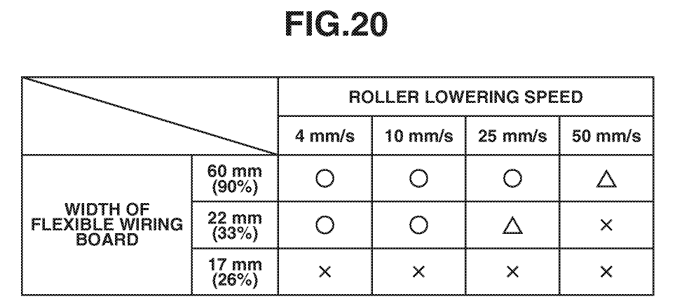

FIG. 20 illustrates results of behavior observation in the bending process when the lowering speed of the roller 941 is changed in the liquid ejection head 100 in which only the width of the bent portion of the flexible wiring board 5 is different. Values in parentheses are percentages of the width of the flexible wiring board 5 to the width of the contact wiring board 6 (i.e., width of flexible wiring board 5 ÷ width of contact wiring board 6 × 100). Determination criteria in the table is as follows: ○ (circle) indicates that the flexible wiring board 5 is bendable, ∆ (triangle) indicates that the flexible wiring board 5 is bendable, but the behavior of the flexible wiring board 5 is unstable due to reaction force at the time of bending or impact at the time of lowering of the roller 942, and × (cross) indicates that the flexible wiring board 5 is not bendable.

In a case where the width was 17 mm (26%), the inclination θ of the contact wiring board 6 before being bent was excessively large, and the contact wiring board 6 interfered with the flow path member 3. As a result, the flexible wiring board 5 was not able to be corrected by the lowering operation of the roller 941. In contrast, in a case where the width was 60 mm (90%), the flexible wiring board 5 was able to be corrected when the lowering speed of the roller 941 was 4 mm/s to 50 mm/s. However, when the lowering speed was 50 mm/s, the behavior of the contact wiring board 6 was unstable because the lowering speed was excessively high. On the other hand, in a case where the width was 22 mm (33%), when the lowering speed was 4 mm/s to 10 mm/s, the flexible wiring board 5 was able to be stably corrected by the lowering operation of the roller 941. When the lowering speed was 25 mm/s, the flexible wiring board 5 was corrected, but the behavior of the contact wiring board 6 was unstable. This is considered to be attributable to the influence of reaction force of the flexible wiring board 5 and of impact caused by the lowering speed of the roller 941. Accordingly, it was found out based on the results of behavior observation that, in the case where the width of the flexible wiring board 5 is 22 mm (33%), the flexible wiring board 5 can be bent at a lowering speed of the roller 942 of 10 mm/s.

According to the above-described manufacturing method, in the bending process, the flexible wiring board 5 is bent at a position included in a non-bonded region as a starting point while the contact wiring board 6 and a bending ridgeline of the flexible wiring board 5 are corrected to be parallel to the side L of the support member 2. As a result, it is possible to manufacture a liquid ejection head having a configuration in which the flexible wiring board 5 is connected in a region, to which the flexible wiring board 5 is offset, having a length less than or equal to half of a length of the contact wiring board 6 in a width direction.

### Second Embodiment

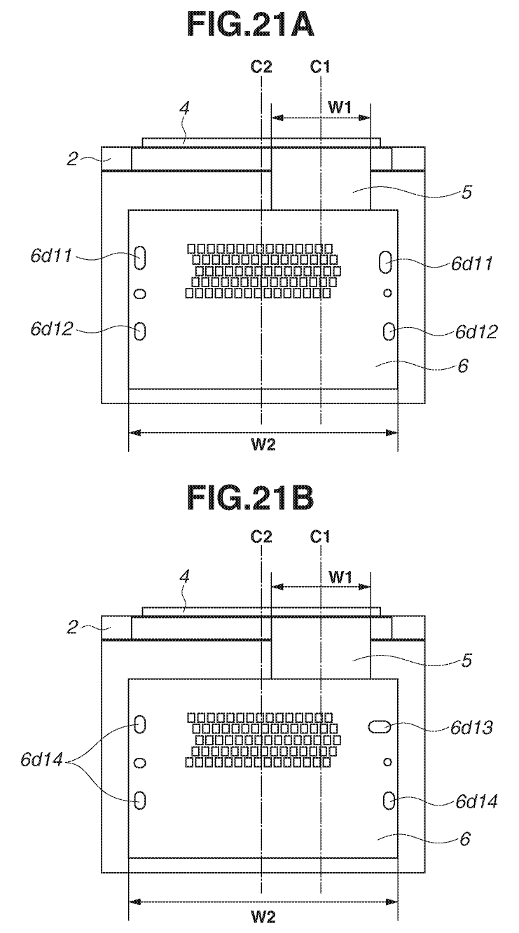

A second embodiment will be described with reference to FIGS. 21A and 21B. For conciseness, description of contents that are the same as in the first embodiment is incorporated by reference, without being repeated. A process of bending a flexible wiring board 5 is similar to the process described with reference to FIGS. 15A-15C.

FIGS. 21A and 21B are views of a liquid ejection head 100 for describing holes 6d1 in a contact wiring board 6 according to the second embodiment as viewed from a contact wiring board 6 side. In a configuration illustrated in FIG. 21A, two holes 6d11 on the bent portion side each have a vertically elongated elliptical shape with an opening area larger than that of the other holes 6d12. The configuration is particularly effective in a case where the contact wiring board 6 is corrected in the vertical direction.

In another configuration illustrated in FIG. 21B, between the holes 6d1 on the bent portion side, a hole 6d13 closest to the flexible wiring board 5 has a horizontally elongated elliptical shape with an opening area larger than that of the other holes 6d14. The configuration is effective in a case where, in correction of the position of the contact wiring board 6 as illustrated in FIGS. 15A-15C at the time of bending of the flexible wiring board 5, a pin 3a is first inserted into the hole 6d13, and then correction in the horizontal direction is performed.

In other words, it is sufficient that, among the holes 6d13 and 6d14 in the contact wiring board 6, a gap between the hole 6d13, which has the opening area larger than those of the other holes, and the pin 3a is maintained as a tolerance clearance for correcting and guiding the contact wiring board 6 during insertion of the pin 3a. Thus, the gap acts as a guide when the pin 3a is first inserted into the hole 6d13 in the contact wiring board 6, and the opening area of the hole 6d13 into which the pin 3a is first inserted may be increased within a permissible range. In FIG. 21B, the hole 6d13 has the horizontally elongated elliptical shape, but the shape is not limited thereto.

As long as the hole 6d13 has an opening area larger than that of a hole 6d14, the hole 6d13 may have a vertically elongated elliptical shape, a simple circular shape, or other shapes.

### Modifications

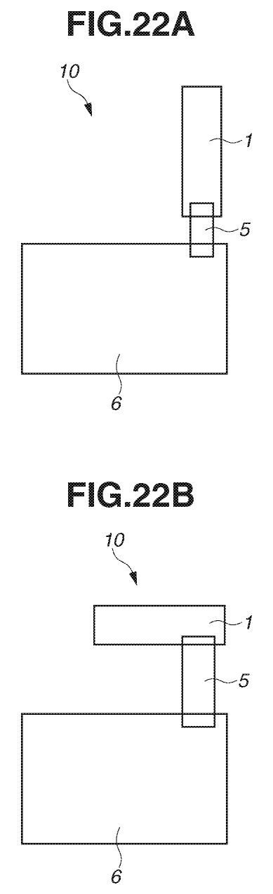

As modifications of the configuration in which the flexible wiring board 5 is connected in the region, to which the flexible wiring board 5 is offset, having the length less than or equal to half of the length of the contact wiring board 6 in the width direction, configurations as illustrated in FIGS. 22A and 22B may be employed. In the configuration illustrated in FIG. 22A, the electrode terminals are provided on a short side of the element substrate 1 and are electrically connected to the flexible wiring board 5. In the configuration illustrated in FIG. 22B, a long side of the element substrate 1 is disposed facing a side of the contact wiring board 6, and the electrode terminals are provided on a part of the long side of the element substrate 1 in the longitudinal direction and are electrically connected to the flexible wiring board 5. The orientation of the element substrate 1, the arrangement of the terminals, and the like may be determined based on ejection performance, an arrangement of the liquid ejection head inside the liquid ejection apparatus, the number of electrical contacts, and the like. In any configuration, the effect of the present disclosure can be produced.

### Other Embodiments

The present disclosure includes the following configurations.

### Configuration 1

A liquid ejection head mounted on a liquid ejection apparatus, the liquid ejection head comprising:
an element substrate configured to eject liquid;
a flexible wiring board electrically connected to the element substrate; and
a contact wiring board including a plurality of contact pads configured to electrically connect to the liquid ejection apparatus and an electrical connection portion with the flexible wiring board, the electrical connection portion extending in a first direction,
wherein the electrical connection portion is disposed in a region having a length less than or equal to half of a length of the contact wiring board in the first direction.

### Configuration 2

The liquid ejection head according to configuration 1, wherein the region is offset to one side of a center of the length of the contact wiring board in the first direction.

### Configuration 3

The liquid ejection head according to configuration 1 or 2, wherein the liquid ejection head is a serial-type liquid ejection head configured to eject liquid to a medium while performing scanning.

### Configuration 4

The liquid ejection head according to any one of configurations 1 to 3, wherein only the flexible wiring board is connected to the contact wiring board.

### Configuration 5

The liquid ejection head according to any one of configurations 1 to 4, further comprising:
a support member configured to support the element substrate; and
a flow path member configured to support the support member and the contact wiring board to supply the liquid to the element substrate.

### Configuration 6

The liquid ejection head according to configuration 5, wherein the contact wiring board is fixed by staking to the flow path member through a plurality of through holes provided in the contact wiring board.

### Configuration 7

The liquid ejection head according to configuration 6, wherein, of the plurality of through holes, a through hole closest to the electrical connection portion has a largest opening area.

### Configuration 8

The liquid ejection head according to configuration 6, wherein the through hole closest to the electrical connection portion has a vertically elongated or horizontally elongated elliptical shape.

### Configuration 9

The liquid ejection head according to any one of configurations 5 to 8, wherein the support member supports the flexible wiring board and the element substrate on a first surface, and is connected to the flow path member on a second surface opposed to the first surface.

### Configuration 10

The liquid ejection head according to any one of configurations 5 to 9,
wherein the flexible wiring board is fixed to a first surface of the support member with an adhesive, and
wherein the support member includes a groove configured to house the adhesive between a bending starting point of the flexible wiring board and the element substrate in a direction parallel to the first surface.

### Configuration 11

The liquid ejection head according to any one of configurations 1 to 10, further comprising:
a cover member configured to cover the flexible wiring board,
wherein the cover member includes an opening configured to expose the element substrate.

### Configuration 12

The liquid ejection head according to configuration 11, wherein the cover member is fixed to the flexible wiring board with an adhesive, and forms a space to house the adhesive.

### Configuration 13

The liquid ejection head according to configuration 12, wherein the space is positioned between a bending starting point of the flexible wiring board and the element substrate in a direction parallel to a surface of the cover member.

### Configuration 14

The liquid ejection head according to any one of configurations 1 to 13, further comprising:

a circulation unit including a pump, and configured to circulate the liquid between the circulation unit and the element substrate.

### Configuration 15

The liquid ejection head according to configuration 1,
further comprising: a plurality of the circulation units,
wherein each circulation unit of the plurality of the circulation units includes a pump configured to circulate the liquid.

### Configuration 16

The liquid ejection head according to any one of configurations 1 to 15, wherein the element substrate includes a plurality of electrode terminals electrically connected to the flexible wiring board.

### Configuration 17

The liquid ejection head according to configuration 16, wherein the plurality of electrode terminals is arranged along a long side of the element substrate.

### Configuration 18

The liquid ejection head according to configuration 17, wherein the long side of the element substrate is disposed in a second direction intersecting the first direction.

### Configuration 19

The liquid ejection head according to any one of configurations 1 to 18, wherein a width of the flexible wiring board in the first direction is less than or equal to half of the length of the contact wiring board in the first direction.

According to the present disclosure, the manufacturing cost of a liquid ejection head can be reduced.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-064133, filed April 9, 2025, which is hereby incorporated by reference herein in its entirety.

What is claimed is:

1. A liquid ejection head mounted on a liquid ejection apparatus, the liquid ejection head comprising:
an element substrate configured to eject liquid;
a flexible wiring board electrically connected to the element substrate; and
a contact wiring board including a plurality of contact pads configured to electrically connect to the liquid ejection apparatus and an electrical connection portion with the flexible wiring board, the electrical connection portion extending in a first direction,
wherein the electrical connection portion is disposed in a region having a length less than or equal to half of a length of the contact wiring board in the first direction.

2. The liquid ejection head according to claim 1, wherein the region is offset to one side of a center of the length of the contact wiring board in the first direction.

3. The liquid ejection head according to claim 1, wherein the liquid ejection head is a serial-type liquid ejection head configured to eject liquid to a medium while performing scanning.

4. The liquid ejection head according to claim 1, wherein only the flexible wiring board is connected to the contact wiring board.

5. The liquid ejection head according to claim 1, further comprising:
a support member configured to support the element substrate; and
a flow path member configured to support the support member and the contact wiring board to supply the liquid to the element substrate.

6. The liquid ejection head according to claim 5, wherein the contact wiring board is fixed by staking to the flow path member through a plurality of through holes provided in the contact wiring board.

7. The liquid ejection head according to claim 6, wherein, of the plurality of through holes, a through hole closest to the electrical connection portion has a largest opening area.

8. The liquid ejection head according to claim 6, wherein the through hole closest to the electrical connection portion has a vertically elongated or horizontally elongated elliptical shape.

9. The liquid ejection head according to claim 5, wherein the support member supports the flexible wiring board and the element substrate on a first surface, and is connected to the flow path member on a second surface opposed to the first surface.

10. The liquid ejection head according to claim 5,
wherein the flexible wiring board is fixed to a first surface of the support member with an adhesive, and
wherein the support member includes a groove configured to house the adhesive between a bending starting point of the flexible wiring board and the element substrate in a direction parallel to the first surface.

11. The liquid ejection head according to claim 1, further comprising:
a cover member configured to cover the flexible wiring board,
wherein the cover member includes an opening configured to expose the element substrate.

12. The liquid ejection head according to claim 11, wherein the cover member is fixed to the flexible wiring board with an adhesive, and forms a space to house the adhesive.

13. The liquid ejection head according to claim 12, wherein the space is positioned between a bending starting point of the flexible wiring board and the element substrate in a direction parallel to a surface of the cover member.

14. The liquid ejection head according to claim 1, further comprising:
a circulation unit including a pump, and configured to circulate the liquid between the circulation unit and the element substrate.

15. The liquid ejection head according to claim 1, further comprising:
a plurality of the circulation units,
wherein each circulation unit of the plurality of the circulation units includes a pump configured to circulate the liquid.

16. The liquid ejection head according to claim 1, wherein the element substrate includes a plurality of electrode terminals electrically connected to the flexible wiring board.

17. The liquid ejection head according to claim 16, wherein the plurality of electrode terminals is arranged along a long side of the element substrate.

18. The liquid ejection head according to claim 17, wherein the long side of the element substrate is disposed in a second direction intersecting the first direction.

19. The liquid ejection head according to claim 1, wherein a width of the flexible wiring board in the first direction is less than or equal to half of the length of the contact wiring board in the first direction.

20. An ejection head comprising:
an element substrate;
a flexible wiring board;
a contact wiring board;
a plurality of contact pads; and
an electrical connection portion, wherein
the flexible wiring board is electrically connected to the element substrate,
the contact wiring board is rectangular shaped in plan view,
a first side of the contact wiring board is longer than an adjacent second side of the contact wiring board, and
the plurality of contact pads extend along the first side of the contact wiring board.
